(19) United States
(12) Patent Application Publication
(10) Pub. No.: US 2010/0005021 A1
(43) Pub. Date: Jan. 7, 2010

(54) Method and system for buying and selling certified emission reduction credits

(75) Inventors: Paul Jonas Ezekiel, New York, NY (US); Gia D. Schneider, Bear, DE (US)

Correspondence Address: KING & SPALDING;CREDIT SUISSE SECURITIES (USA) LLC, 1180 PEACHTREE STREET, NE, 34TH FLOOR, ATLANTA, GA, 30309-3521, US

(73) Assignee: Credit Suisse Securities (USA) LLC, New York, NY (US)

(21) Appl. No.: 12/316,920

(22) Filed: Dec. 17, 2008

Related U.S. Application Data
(60) Provisional application No. 61/014,310, filed on Dec. 17, 2007.

(51) Int. Cl. G06Q 40/00; G06Q 50/00

(52) U.S. Cl. 705/37

(57) ABSTRACT

Distributing units of carbon emission reduction (“CER”) comprises obtaining a right to purchase CERs in the future that are developed by emission reduction projects, dividing the future CERs into a plurality of tranches, committing the future CERs in the tranches to prospective buyers, and distributing CERs received from the projects to the prospective buyers based on a priority of delivery between the tranches. A contingent call option can provide replacement CERs to meet CER obligations to a senior tranche if received CERs are not sufficient to meet the obligations of future CERs allocated to buyers in the senior tranche. CERs are not distributed to buyers of junior tranches if the received CERs are not sufficient to meet the CER obligations to more senior tranches.

### RELATED APPLICATIONS

This application claims priority to U.S. Provisional patent application No. 61/014,310 filed Dec. 17, 2007 and entitled “Structured Certified Emission Reduction Portfolio Sale.” The complete disclosure of the above-identified priority application is hereby fully incorporated herein by reference.

### TECHNICAL FIELD

The present invention relates to a market for certified emission reduction credits. More particularly, the present invention relates to structures, systems, and methods for purchasing and selling certified emission reduction credits.

### BACKGROUND

Burning of fossil fuels can produce greenhouse gases, such as carbon dioxide, methane, nitrous oxide, and hydrofluorocarbons (HFCs). Excessive amounts of greenhouse gases are believed to be harmful to the environment. Accordingly, mechanisms have been developed to control or limit the amount of greenhouse gases produced by particular countries and/or particular industries or companies.

The Kyoto Protocol is one such mechanism for controlling greenhouse gas emissions. Under the Kyoto Protocol, member countries agreed to caps on the maximum amount of greenhouse gases to be produced in their respective countries. Then, each country sets caps on the emissions produced by specific businesses within the country to keep the total amount of greenhouse gases produced within a country below the cap for that country. The greenhouse gas emissions are measured in units, where each unit provides the right to emit one metric ton of carbon dioxide or other equivalent greenhouse gas.

Each country allocates its total amount of emissions among the businesses within the country. Businesses that have not used up their allocation can sell their unused allocation as carbon credits. Alternatively, businesses that need or want to exceed their allocation can buy the extra credits from other businesses. Companies also may purchase extra credits to reduce their carbon footprint on a voluntary basis.

A type of carbon credit that has been approved under the Kyoto Protocol is called a certified emission reduction (“CER”) and represents the authorization to emit one ton of carbon dioxide equivalent during a specified period of time. CERs can be traded, bought, and/or sold both locally and internationally and can be considered a freely-transferable, limited-life license. Accordingly, companies will undertake projects to reduce their emissions, which will generate CER credits that can be sold.

The markets for buying and selling CERs are not well established and lead to uncertainty for both buyers and sellers. A company may be hesitant to undertake a project that will generate CER credits because the market price of those CER credits may be unknown or unstable. Additionally, another company may be hesitant to build facilities that require additional CERs if that company is not confident that it can obtain the necessary CERs in the future. To obtain a large number of CERs may require contracting with multiple entities that are undertaking CER generating projects. That task can be too resource intensive to obtain the needed CERs.

Accordingly, a need exists in the art for a structure, system, and method for buying and selling CERs that can provide a better market for CER creators/sellers and CER buyers.

### SUMMARY

The present invention can provide a financial structure, system, and method for buying and selling carbon credits, such as a carbon emission reduction (“CER”). A project developer can create a portfolio of greenhouse emission reduction projects that will generate CERs in the future (“future CERs”) when those projects are completed. A seller agrees to receive/purchase the future CERs when they are actually issued by the projects and, on a specified delivery date, to deliver the future CERs into three tranches, A, B, and C based on a priority of delivery to the tranche buyers. Tranche buyers agree in advance to purchase the future CERs that will be delivered into one or more of the three tranches by the seller. The delivery risk for tranche A buyers is reduced as compared to tranche B and tranche C buyers. All of the CERs received by the seller are delivered first to tranche A buyers until the total obligations to the tranche A buyers for that delivery date are satisfied. In addition, according to one embodiment of the present invention, if sufficient CERs are not received by the delivery date to meet the obligations to the tranche A buyers, then the seller exercises a contingent call option to obtain delivery from a tranche A hedge provider of sufficient replacement CERs to meet those obligations. If sufficient CERs are received by the delivery date to meet the obligations to the tranche A buyers, then any remaining CERs are distributed to the tranche B buyers until the total obligations to the tranche B buyers for that delivery date are satisfied, and then to the tranche C buyers.

The invention can provide an efficient method for a buyer to obtain CERs generated from a portfolio of projects without the buyer having to negotiate with each project entity. Buyers can choose their acceptable level of delivery risk in obtaining CERs by purchasing CERs in one or more tranches that have different levels of delivery protection. Grouping of the projects into the project portfolio presents the prospective buyers with an opportunity to obtain access to large volumes of CERs from a diverse project group, without having to incur the on-the-ground transaction costs of signing individual agreements with an equivalent number of projects.

These and other aspects, objects, and features of the present invention will become apparent from the following detailed description of the exemplary embodiments, read in conjunction with, and reference to, the accompanying drawings.

### BRIEF DESCRIPTION OF THE DRAWINGS

FIG. 1 is a block diagram depicting a financial structure for buying and selling CERs according to an exemplary embodiment.

FIG. 2 is a block diagram depicting a distributed computer system for certified emission reduction credit processing according to an exemplary embodiment.

FIG. 3 is a flow chart depicting a method for buying and selling CERs according to an exemplary embodiment.

FIG. 4 is a flow chart depicting a method for accepting bids to purchase CERs according to an exemplary embodiment.

FIG. 5 is a flow chart depicting a method for distributing CERs to buyers based on tranche CER trade agreements according to an exemplary embodiment.

FIG. 6 is a block diagram depicting a system for buying and selling certified emission reduction credits according to an alternative exemplary embodiment.

### DETAILED DESCRIPTION OF EXEMPLARY EMBODIMENTS

The financial structure and methods described herein can provide a system, structure, and method for buying and selling carbon credits, such as a carbon emission reduction (“CER”). The exemplary embodiments illustrate an efficient method for a buyer to obtain CERs generated from a portfolio of projects without the buyer having to negotiate with each project entity. Buyers can choose their acceptable level of delivery risk in obtaining CERs by purchasing CERs in one more tranches that have different levels of delivery protection. Thus, grouping of the projects 104 into the project portfolio presents the prospective buyers 108a, 108b, 108c with an opportunity to obtain access to large volumes of CERs from a diverse project group, without having to incur the on-the-ground transaction costs of signing individual agreements with an equivalent number of projects 104.

The invention comprises a computer program and a computer program product, operating on a computer system, that embody the functions described herein and illustrated in the appended flow charts. However, it should be apparent that there could be many different ways of implementing the invention in computer programming, and the invention should not be construed as limited to any one set of computer program instructions. Further, a programmer would be able to write such a computer program to implement an embodiment of the disclosed invention based on the flow charts and associated description in the application text. Therefore, disclosure of a particular set of program code instructions is not considered necessary for an adequate understanding of how to make and use the invention. The inventive functionality of the claimed computer program will be explained in more detail in the following description read in conjunction with the figures illustrating the program flow.

Turning now to the drawings, in which the same numerals represent similar elements, aspects of the exemplary embodiments will be described.

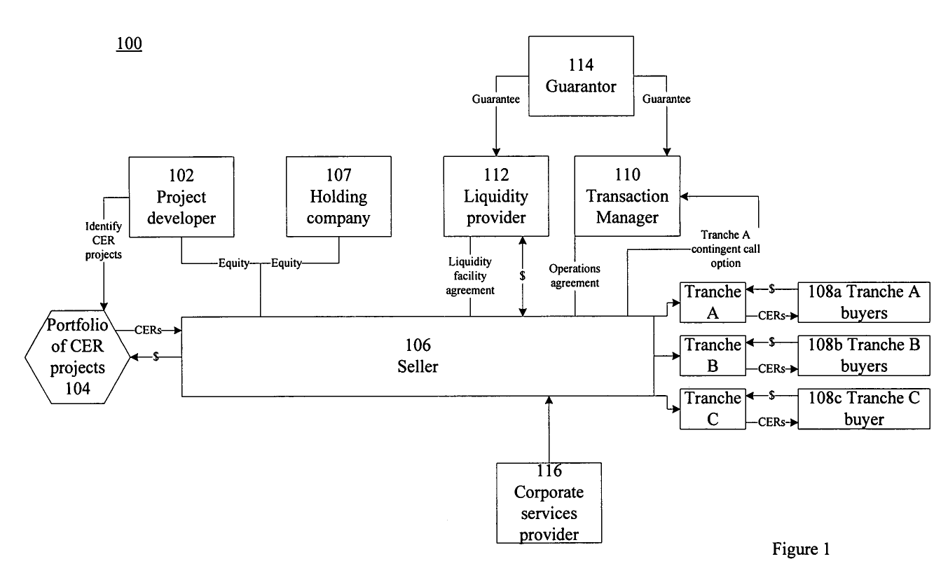

FIG. 1 is a block diagram depicting a financial structure 100 for buying and selling CERs according to an exemplary embodiment. As shown in FIG. 1, the financial structure includes multiple parties that interact with each other to generate CERs through emission reduction projects, buy the generated CERs, and resell the generated CERs.

A project developer 102 is a public company in the business of originating, developing, and trading carbon credits in the Kyoto Protocol markets. The project developer 102 can have knowledge of guiding emission reduction projects 104 through the complex registration process under the Kyoto Protocol and then ultimately to issuance of CERs. Thus, the project developer 102 can identify and assist companies that are creating projects 104 that will generate CERs in the future. For example, the project developer 102 can draft project design documents to describe the project prepared in accordance with the international rules and can select and appoint a designated operational entity that is qualified to validate proposed project activities and to verify and certify reductions in greenhouse gases.

The project developer 102 also can be a shareholder of a seller 106. The seller 106 is a private company with limited liability. The principal business of the seller 106 is to contract with the businesses developing the projects 104 to purchase CERs that are expected to be generated in the future, to receive CERs from the projects 104 when they issue, and to sell those CERs to tranche A, tranche B, and tranche C buyers 108a, 108b, 108c on specified delivery dates in accordance with the terms of CER trade agreements with the buyers 108a, 108b, 108c. In an exemplary embodiment, the issued share capital in the seller 106 can be legally and beneficially owned by a holding company 107 (75%) and the project-developer 102 (25%). Alternative ownership arrangements of the seller 106 also may be suitable. The seller 106 can contract with the buyers 108a, 108b, 108c via tranche CER trade agreements for the future sale of CERs obtained by the seller 106 to the buyers 108a, 108b, 108c. A tranche CER trade agreement is a forward CER sale agreement with non-firm delivery obligations with respect to CERs received by the seller 106 (other than with respect to tranche A) and one-way collateral delivery obligations from the buyers 108a, 108b, 108c to the seller 106.

In exemplary embodiments, the projects 104 can be conducted in one or multiple countries that recognize CERs or similar carbon credits.

A transaction manager 110 is a limited liability company that coordinates the structuring and marketing of the portfolio of projects 104. The principal role of the transaction manager 110 is to coordinate the structuring and marketing of the sale of CERs from the projects 104. As such, the transaction manager 110 is responsible for coordinating the selection of the projects 104 with the project developer 102, developing the overall deal structure, and running the book building process whereby the prospective buyers 108a, 108b, 108c will ultimately enter into the tranche CER trade agreements with the seller 106 for the purchase of future CERs.

The transaction manager 110 provides operational support services, such as assisting with the transfer of CERs and invoicing, to the seller 106 via an operations agreement. Additionally, the transaction manager 110 in its role as a tranche A hedge provider enters into a tranche A contingent call option with the seller 106. The tranche A contingent call option will gives the seller 106 a right to exercise a call obligating the transaction manager 110 to deliver to the seller 106 a number of CERs equal to any shortfall in project CERs required to be delivered by the seller 106 to the tranche A buyers 108a on a particular delivery date. In an exemplary embodiment, the transaction manager 110 can act as a calculation agent to calculate an amount of damages payable under the CER trade agreements with the tranche A, B, and C buyers 108a, 108b, 108c and can facilitate the transfer of the CERs. Alternatively, this function can be performed by another one of the entities identified in FIG. 1, such as the seller 106.

A liquidity facility provider 112 is a special purpose corporation and can be an asset backed commercial paper conduit. Under the terms of a liquidity facility agreement with the seller 106, the liquidity facility provider provides a revolving funding facility to the seller 106 for the seller 106 to acquire CERs that become available from the projects 104. In an exemplary embodiment, the seller 106 can make up to a specified number, for example, 4, annual draws from the liquidity facility provider. The seller 106 is obligated to repay all amounts drawn under the liquidity facility agreement, including any accrued interest, on an annual basis, typically corresponding to the delivery date of CERs to the buyers 108a, 108b, 108c.

The liquidity facility provider has the benefit of a guarantee from a guarantor 114, which guarantees the payment obligations of the seller 106 via a liquidity guarantee agreement between the relevant parties. Additionally, the guarantor 114 also guarantees the tranche A contingent call option obligations of the transaction manager 110 via a contingent call guarantee agreement between the relevant parties. The guarantor 114 takes security over certain assets of the seller 106, such as cash and the benefit of the CER trade agreements with the buyers 108a, 108b, 108c, as security for the guarantees.

The seller 106 purchases the tranche A contingent call option and the guarantees using funds from the liquidity facility provider.

A corporate services provider 116 is a company incorporated in the same country as the seller 106. The corporate services provider 116 provides certain administrative and secretarial services to the seller 106, such as a registered office, an independent director, company secretary, corporate compliance, book keeping, financial reporting, and other suitable services to the seller 106.

The buyers 108a of the tranche A CERs have “priority of delivery” (as described hereinafter) over the buyers 108b and 108c of tranches B and C CERs, respectively. In addition, according to one exemplary embodiment of the present invention, the buyers 108a of the tranche A CERs under tranche CER trade agreements are not subject to underlying delivery performance of the projects 104 by virtue of the tranche A contingent call option. In this exemplary embodiment, the tranche A contingent call option allows the seller 106 to call for delivery of replacement CERs from the tranche A hedge provider to ensure that the tranche A buyers 108a receive all CERs due on each delivery date. Accordingly, the tranche A CERs will typically be priced higher with regard to CERs in other tranches due to their senior priority and, in some cases, the certainty of receiving the tranche A CERs.

The buyers 108b of the tranche B CERs have subordinate “priority of delivery” to the buyers 108a of the tranche A CERs, but have senior “priority of delivery” to the buyers 108c of the tranche C CERs. In addition, according to one exemplary embodiment of the present invention, the buyers 108b of the tranche B CERs under tranche CER trade agreements do not benefit from the tranche A contingent call option. Tranche B CERs will typically be priced lower with regard to CERs in tranche A due to the subordinate relationship to tranche A and the uncertainty of receiving the tranche B CERs.

The buyers 108c of the tranche C CERs have subordinate “priority of delivery” to the buyers 108b of the tranche B CERs. In addition, according to one exemplary embodiment of the present invention, the buyers 108c of the tranche C CERs under a tranche CER trade agreement also do not benefit from the tranche A contingent call option. The tranche C CERs will typically be priced lower than the tranche B CERs due to the subordinate relationship to tranche B and the uncertainty of receiving the tranche C CERs. In an exemplary embodiment, the tranche C buyers can include the project developer 102.

In an exemplary embodiment, the tranche allocation of total CERs expected to be produced by the projects 104 can be 25% in tranche A, 45% in tranche B, and 30% in tranche C. Other suitable tranche allocations are within the scope and spirit of the present invention.

Under the CER trade agreements, the seller 106 is to deliver the contracted amounts of CERs to the buyers 108a, 108b, 108c on specified delivery dates. For example, the trade agreements can specify an annual delivery date for a particular number of years, such as four years. On each delivery date, the transaction manager 110 determines how many CERs the seller 106 has accumulated from the projects 104 and calculates how to distribute the accumulated CERs to the buyers 108a, 108b, 108c.

The accumulated CERs are delivered to the buyers 108a, 108b, 108c according to the following “priority of delivery”: With respect to any scheduled delivery date, all received CERs on the relevant delivery date will be delivered in the following order of priority:

(i) first, pari passu (in equal proportion) towards satisfaction of the seller's 106 delivery obligations to the tranche A buyers 108a—until all of the tranche A buyers 108a have received the total CERs purchased in tranche A with respect to that delivery date or until all received CERs are delivered, whichever occurs first. If the seller obtained a contingent call option for the tranche A CERs, then replacement CERs will be obtained from the transaction manager 110 acting as a tranche A hedge provider, if needed, to meet all tranche A CER obligations to the tranche A buyers;

(ii) second, if any received CERs remain after exhausting all delivery obligations to the tranche A buyers 108a, pro rata and pari passu, towards satisfaction of the seller's 106 delivery obligations to the tranche B buyers 108b—until all CERs are delivered or until the tranche B buyers 108b have received the total CERs purchased in tranche B with respect to that delivery date, whichever occurs first; and

(iii) third, if any received CERs remain after exhausting all delivery obligations to the tranche A buyers 108a and tranche B buyers 108b, the remaining CERs will be delivered to the tranche C buyer.

Thus, grouping of the projects 104 into the project portfolio presents the prospective buyers 108a, 108b, 108c with an opportunity to obtain access to large volumes of CERs from a diverse project group, without having to incur the on-the-ground transaction costs of signing individual agreements with an equivalent number of projects 104. The origination effort has already been expended to identify, screen, and contract each of the projects 104 by the transaction manager 110 and/or the project developer 102.

Alternative exemplary structures based on the parties illustrated in FIG. 1 are within the scope and spirit of the invention. Certain entities illustrated in FIG. 1 are optional, and/or functions of the entities illustrated in FIG. 1 can be performed by a different entity than as described above. For example, the project developer 102 is an optional party. In the absence of the project developer, the holding company 107, the transaction manager 110, and/or the seller 106 can perform the project identification and other functions described above with regard to the project developer 102. Additionally, consultants (not shown) can be engaged to provide project identification and development assistance to any of these entities.

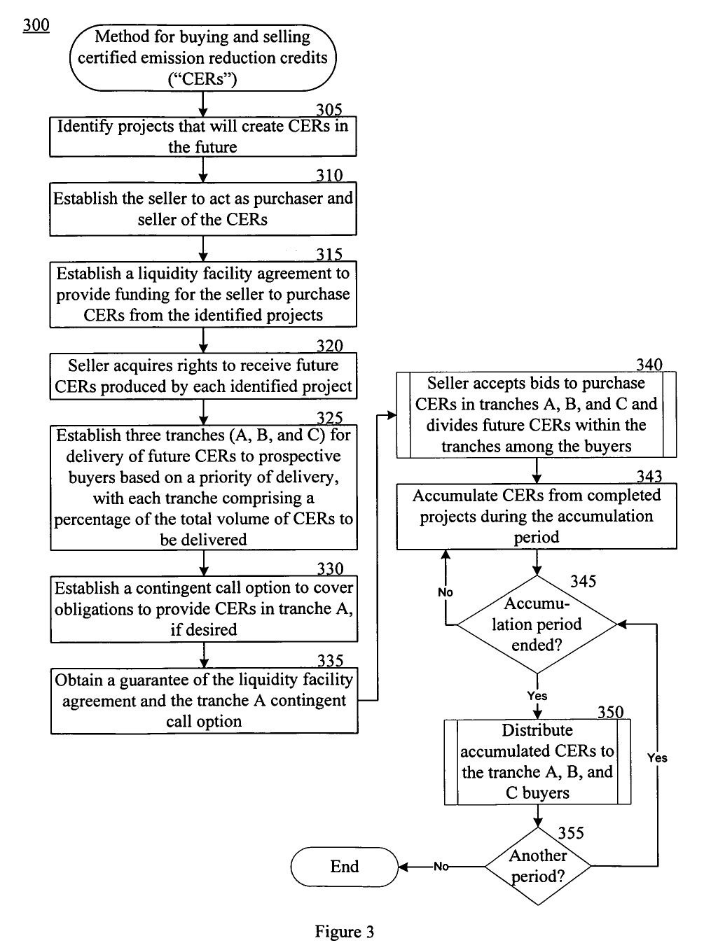

The structure of FIG. 1 will be described in further detail hereinafter with reference to FIGS. 3-5.

FIG. 3 is a flow chart depicting a method 300 for buying and selling CERs according to an exemplary embodiment. In step 305, the project developer 102 identifies projects 104 that will create CERs in the future and develops a portfolio comprising multiple CER creating projects 104. For example, such projects 104 can include building new facilities that will reduce a company's greenhouse gas emissions to thereby create an excess amount of CERs that the company can sell. In an exemplary embodiment, the transaction manager 110 can assist the project developer 102 in performing this step.

In an exemplary embodiment, a CER is a unit issued pursuant to article 12 of the Kyoto Protocol and the decisions adopted pursuant to the United Nations Framework Convention for Climate Change or the Kyoto Protocol which may be used for compliance purposes in accordance with a scheme for greenhouse gas emissions allowance trading. Alternatively, a CER can be a unit representing another suitable greenhouse gas emissions allowance. Each project will result in a reduction in greenhouse gas emissions that equate to CERs that can be sold.

In step 310, the seller 106 is established to act as the purchaser and seller of the CERs created by the projects 104. Additionally, in step 315, the liquidity facility agreement is established between the liquidity provider 112 and the seller 106 to provide funding for the seller 106 to purchase CERs from the identified projects 104 and to purchase the guarantees (step 335).

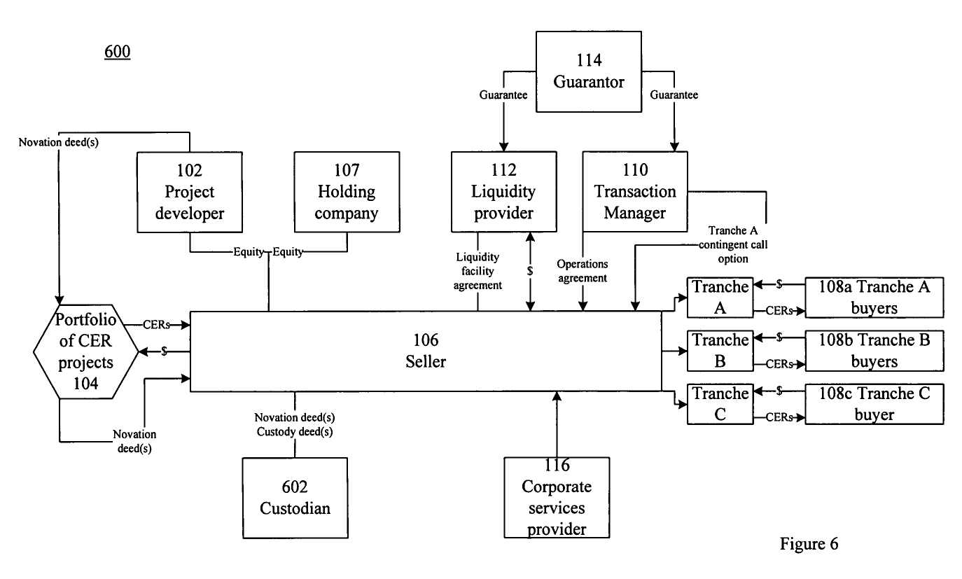

Then, the seller 106 acquires rights in step 320 to receive CERs produced by each of the identified projects 104 in the future (“future CERs”). In an exemplary embodiment, the seller 106 can execute purchase agreements to purchase future CERs produced by each of the identified projects 104. For example, the seller 106 can enter into an emission reduction purchase agreement with the respective entities responsible for each of the projects 104 for the purchase of generated CERs at a CER unit price. The CER unit price is a price per CER that the seller 106 will pay to the entities for the CERs. In an alternative exemplary embodiment, the seller 106 can enter into purchase agreements with one or more other parties that have rights to purchase the future CERs. For example, the seller 106 may contract with the project developer 102 or another entity to purchase the CERs from the project developer 102, which has obtained the rights to the future CERs from the projects 104. This transfer may occur via a novation agreement, as discussed hereinafter with reference to FIG. 6.

In step 325, the transaction manager 110 establishes three tranches (A, B, and C) for delivery of the future CERs to the buyers 108a, 108b, 108c based on a priority of delivery among the tranches A, B, and C. The tranches A, B, and C each comprise a percentage of the total quantity of future CERs to be received by the seller 106 from the projects 104 and to be delivered to the buyers 108a, 108b, 108c based on the priority of delivery for the tranches. In an exemplary embodiment, the future CERs can be divided into three equal tranches. Alternatively, the CERs can be allocated in different amounts into the tranches. Additionally, two or more tranches may be used, as long as the tranches are established based on a seniority basis to provide the priority of delivery. Additionally, the most senior tranche may benefit from the tranche A contingent call option. In an exemplary allocation, 25% of future CERs are allocated to tranche A, 45% of future CERs are allocated to tranche B, and 30% of future CERs are allocated to tranche C. In an alternative exemplary allocation, 25% of future CERs are allocated to tranche A, 50% of future CERs are allocated to tranche B, and 25% of future CERs are allocated to tranche C.

In step 330, if desired, the seller 106 purchases a contingent call option from the transaction manager 110 acting as a tranche A hedge provider to cover obligations to provide the CERs in tranche A. As previously discussed, the transaction manager 110 can agree to provide replacement CERs to fulfill all tranche A CER obligations of the seller 106 in the event that the projects 104 do not generate sufficient CERs to meet those obligations by a specified delivery date.

In step 335, the transaction manager 110 obtains (1) a guarantee from the guarantor 114 to meet the obligations of the seller 106 to the liquidity facility provider 112 for providing the funds to purchase the CERs from the projects 104 and (2) a guarantee from the guarantor 114 to meet the obligations of the transaction manager 110 under the tranche A contingent call option.

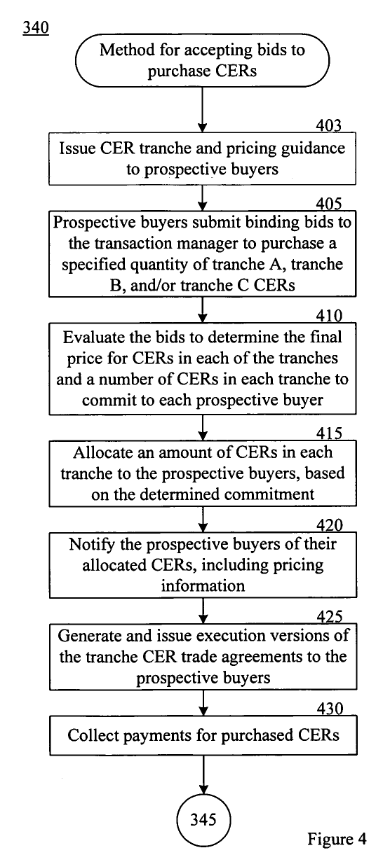

After establishing the projects 104, the various entities and their relationships, and the tranches in steps 305-335, the seller 106 accepts bids in step 340 to purchase future CERs in tranches A, B, and C from prospective buyers 108a, 108b, 108c and divides the future CERs in the tranches A, B, and C among those buyers 108a, 108b, 108c. In its role as operations support, the transaction manager 110 may perform the bid acceptance and allocation steps on behalf of the seller 106. Step 340 will be described hereinafter with reference to FIG. 4.

In step 343, the seller 106 accumulates CERs from projects 104 completed during the accumulation period. The accumulation period defines a specified period of time in which the seller 106 accumulates CERs (“accumulated CERs”) from projects 104 that are completed during that time period. Projects 104 are completed when the requirements are met for a CER to become a credit that is transferable according to the applicable regulations. In exemplary embodiments, the accumulation is accomplished by transferring issued CERs into a registry account of the seller 106, and the accumulation period is the period from the completion of step 340 to the first delivery date on which the seller 106 will distribute CERs to the buyers 108a, 108b, 108c or the period from one delivery date to the next delivery date.

Then, in step 345, the method 300 determines whether the current accumulation period has ended. If the current accumulation period has not ended, then the method 300 branches back to step 343 to continue to accumulate CERs during the accumulation period, and the method 300 repeats step 345 until the end of the accumulation period occurs.

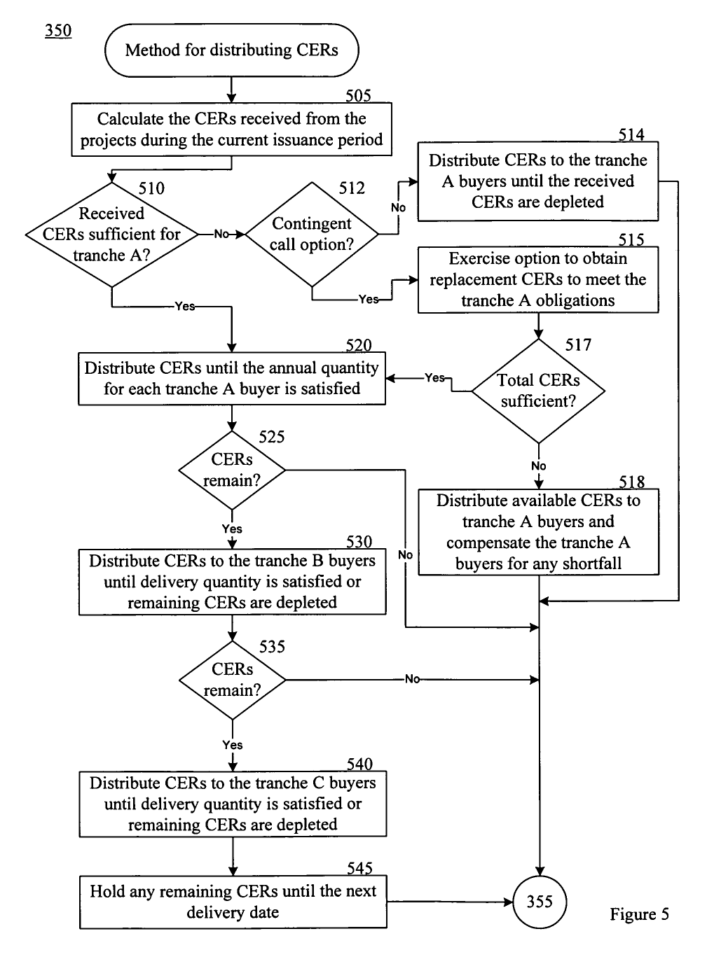

Upon determining that the accumulation period has ended, the method 300 branches to step 350 where the seller 106 distributes CERs accumulated during the period to the tranche A, B, and C buyers 108a, 108b, 108c. In its role as operations support, the transaction manager 110 may perform the distribution steps on behalf of the seller 106. Step 350 will be described in further detail hereinafter with reference to FIG. 5.

After distributing the accumulated CERs, the method 300 determines in step 355 whether another accumulation period exists in the agreements between the projects 104, the seller 106, and the tranche A, B, and C buyers 108a, 108b, 108c. If yes, then the method 300 branches back to step 345 to determine when the next accumulation period ends. If not, then the method 300 ends.

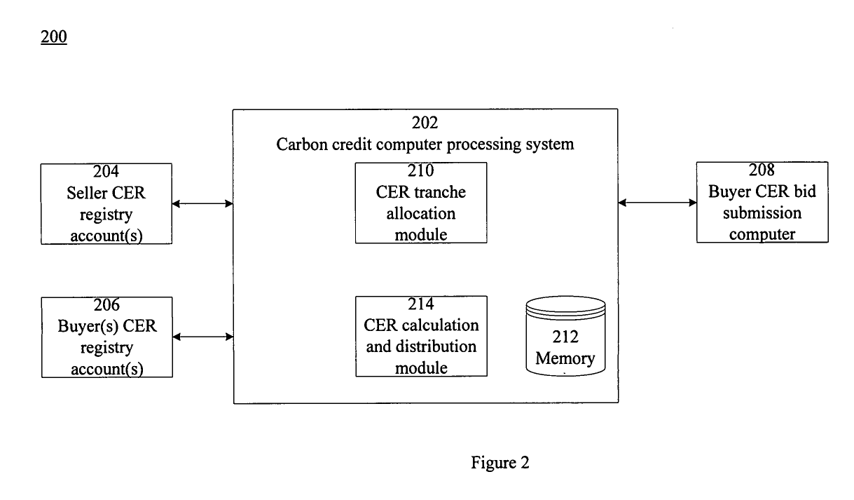

FIG. 2 is a block diagram depicting a distributed computer system 200 for certified emission reduction credit processing according to an exemplary embodiment. As shown, the system 200 comprises a carbon credit computer processing system 202 that interfaces with seller and buyer registry accounts 204, 206 and a buyer CER bid submission computer 208 via one or more networks (not shown), such as the Internet. In exemplary embodiments, the carbon credit computer processing system 202 can perform the allocation, accumulation period monitoring, and distribution steps described with reference to steps 325, and 340-350 of FIG. 3 and as described in more detail hereinafter. Additionally, the carbon credit computer processing system 202 can be located at the transaction manager 110 or the seller 106 depending on which entity will perform certain functions. Alternatively, portions of the carbon credit computer processing system 202 can be distributed at both the transaction manager 110 and the seller 106, as desired. The carbon credit computer processing system 202 is a computer system that comprises instructions stored in a machine-readable medium and a processor that executes the instructions, as described in more detail hereinafter.

The system 200 will be described in further detail hereinafter with reference to FIGS. 4-5. FIG. 4 is a flow chart depicting a method 340 for accepting bids to purchase CERs according to an exemplary embodiment, as referenced in step 340 of FIG. 3.

In step 403, the seller 106 (or the transaction manager 110) issues pricing guidance to the prospective buyers 108a, 108b, 108c for purchasing future CERs in the tranches A, B, and C. Exemplary pricing guidance may include a minimum number of CERs required to be purchased in each tranche and a projected price range for CERs in each tranche. Then, in step 405, prospective buyers 108a, 108b, 108c submit binding bids to the transaction manager 110 to purchase a specified quantity of tranche A, tranche B, and/or tranche C CERs in the future. In an exemplary embodiment, the buyers 108a, 108b, 108c enter their bids into their respective bid submission computers 208 and submit their bids to the carbon credit computer processing system 202 via the network. At the carbon credit computer processing system 202, a CER tranche allocation module 210 receives the bids and stores the bids in a memory 212.

In an exemplary embodiment, bids may only be accepted for tranches A and B, where CERs in tranche C will be allocated to the project developer 102 or another entity within the structure illustrated in FIG. 1.

In step 410, the CER tranche allocation module 210 evaluates the received bids to determine the final price for CERs in each tranche and a number of CERs in each tranche to be committed to each of the buyers 108a, 108b, 108c. This process can involve multiple iterations based on subsequent input from the prospective buyers 108a, 108b, 108c and a sales team of the seller 106 or the transaction manager 110 to arrive at a suitable division and commitment of the CERs, including a unit price for each CER in each of the tranches, to the prospective buyers 108a, 108b, 108c for each of the tranches A, B, and C.

Then, in step 415, the transaction manager 110 allocates CERs in each tranche to the prospective buyers 108a, 108b, 108c based on the pricing and commitment determined in step 410. The CER tranche allocation module 210 also communicates the allocations to the memory 212 for future reference.

In step 420, the transaction manager 110 notifies prospective buyers 108a, 108b, 108c of their allocated CERs, including pricing information. Then, in step 425, the transaction manager 110 generates and issues execution versions of the tranche CER trade agreements, stating the allocated amount and price for each tranche for specific buyers 108a, 108b, 108c for execution by the respective buyers 108a, 108b, 108c, and the buyers 108a, 108b, 108c sign and return their respective agreements.

In step 430, the transaction manager 110 collects payments for purchased CERs from the tranche buyers 108a, 108b, 108c. Payments may be made electronically by suitable electronic methods, including electronic funds transfer, from the buyers 108a, 108b, 108c to an account of the seller 106 or the transaction manager 110. Step 430 may be performed upon execution of the CER trade agreements by the buyers 108a, 108b, 108c. Alternatively, step 430 may be deferred until distribution of the CERs to the tranche buyers 108a, 108b, 108c, at which time the buyers 108a, 108b, 108c pay for CERs that are distributed to them.

From step 430, the method 340 proceeds to step 345 (FIG. 3).

FIG. 5 is a flow chart depicting a method 350 for distributing CERs to the buyers 108a, 108b, 108c based on the tranche CER trade agreements according to an exemplary embodiment, as referenced in step 350 of FIG. 3. In step 505, the CER calculation and distribution module 214 of the carbon credit computer processing system 202 calculates the CERs received (“accumulated CERs”) from the projects 104 during the current accumulation period. For example, the CER calculation and distribution module 214 may sum the CERs received from all projects 104 during the current accumulation period. Alternatively, the CER calculation and distribution module 214 may access the seller 106 registry account 204 via the network to identify the number of CERs deposited into the account 204 during the accumulation period. In an exemplary embodiment, the accumulated CERs also can include CERs of the seller existing prior to the accumulation period, such as CERs carried over from a prior accumulation period. The seller 106 registry account(s) 204 (and the buyer registry accounts 206) are registries established by members to the applicable agreement, such as the Kyoto Protocol, to ensure the accurate tracking of the issue, holding, transfer, acquisition, surrender, cancellation, and replacement of CERs. Accordingly, the seller registry account(s) 204 will include a record of CERs owned by the seller 106 as of the end of the allocation period, which equals the number of CERs accumulated by the seller 106 during the accumulation period.

In step 510, the CER calculation and distribution module 214 determines whether sufficient CERs were generated to meet the obligations for the tranche A buyers 108a. The CER calculation and distribution module 214 makes this determination by subtracting the number of required CERs from the number of accumulated CERs. Sufficient CERs were generated if the accumulated CERs are equal to or greater than the required CERs. If not, then the method 350 branches to step 512 in which the calculation and distribution module 214 determines whether the seller 106 has obtained a contingent call option to guarantee the CER obligations to the tranche A buyers 108a. If not, then the method 350 branches to step 514. In step 514, the CER calculation and distribution module 214 distributes CERs to the tranche A buyers 108a until the received CERs are exhausted. In this case, the CER calculation and distribution module 214 will distribute CERs to the tranche A buyers 108a in proportion to the amount of CERs each buyer purchased in tranche A until the received CERs are depleted. In an exemplary embodiment, the CER calculation and distribution module 214 can debit one or more of the seller CER registry accounts 204 in which the accumulated CERs currently reside and can credit the appropriate CER registry account(s) 206 for each of the tranche A buyers 108a to transfer the CERs from the seller 106 to the respective tranche A buyers 108a. From step 514, the method 350 proceeds to step 355 (FIG. 3), and the CER distribution is complete for the current accumulation period.

Referring back to step 512, if the seller 106 obtained a contingent call option to guarantee the CER obligations to the tranche A buyers 108a, then the method 350 branches to step 515 in which the seller 106 exercises the contingent call option to obtain replacement CERs from the tranche A hedge provider to meet the tranche A CER obligations. In this case, the tranche A hedge provider, in accordance with the tranche A contingent call option, delivers the number of CERs to the seller 106 sufficient to meet the tranche A obligations. In other words, the tranche A hedge provider provides the number of CERs equal to the difference between the required CERs and the accumulated CERs. In an exemplary embodiment, replacement CERs can be transferred to the seller 106 by crediting the CERs to the seller CER registry account 204. In the event that the transaction manager 110 is unable to obtain/provide sufficient replacement CERs to meet the shortfall, then the transaction manager 110 will provide payment sufficient to compensate for the CER shortfall based on an amount reflecting the difference between the then-current market price for CERs and the unit price for CERs under the tranche A CER trade agreement multiplied by the shortfall quantity of CERs.

In step 517, the calculation and distribution module 214 determines whether the accumulated CERs and the replacement CERs are sufficient to meet the tranche A obligations. If not, then the method 350 branches to step 518, in which the calculation and distribution module 214 distributes all available CERs (accumulated CERs and any replacement CERs) to the tranche A buyers 108a and also compensates the tranche A buyers 108a for any shortfall using the payment provided by the transaction manager 110. In an exemplary embodiment, if the transaction manager fails to provide sufficient payment to compensate the tranche A buyers 108a for the CER shortfall, then the seller 106 will have an obligation to compensate the tranche A buyers 108a with such a sufficient payment. The CER calculation and distribution module 214 can distribute the CERs by debiting and crediting the appropriate registry accounts 204, 206, as discussed previously. From step 518, the method 350 branches to step 355 (FIG. 3), and the CER distribution is complete for the current accumulation period.

Referring back to step 517, if the accumulated CERs and the replacement CERs are sufficient to meet the tranche A CER obligations, then the method 350 branches to step 520.

Referring back to step 510, if the CER calculation and distribution module 214 determines that sufficient CERs were received during the current accumulation period to meet the tranche A obligations, then the method 350 branches directly to step 520. The CER calculation and distribution module 214 makes this determination if the required CERs are less than the accumulated CERs.

In step 520, the CER calculation and distribution module 214 distributes CERs to the tranche A buyers 108a until the annual quantity for each tranche A buyer is satisfied. The CER calculation and distribution module 214 can distribute the CERs by debiting and crediting the appropriate registry accounts 204, 206, as discussed previously.

Thus, the tranche A buyers 108a only receive their full amount of CERs if the seller 106 accumulated sufficient CERs during the accumulation period to cover those obligations or if the seller obtained the contingent call option to meet any shortfall in those obligations. The tranche A buyers 108a benefit from the seniority of tranche A over tranches B and C. Additionally, the contingent call option can further reduce CER delivery risk to the tranche A buyers 108a. Accordingly, CERs in tranche A may sell for a higher price than CERs in tranches B and C.

In step 525, the CER calculation and distribution module 214 determines whether any CERs remain to be distributed. The CER calculation and distribution module 214 makes this determination if the accumulated CERs are greater than the required CERs for the tranche A buyers 108a. If not, then the method 350 branches to step 355 (FIG. 3), and the CER distribution is complete for the current accumulation period.

Referring back to step 525, if additional CERs remain to be distributed, then the method 350 branches to step 530 in which the CER calculation and distribution module 214 distributes CERs to the tranche B buyers 108b. In this case, the CER calculation and distribution module 214 will distribute CERs to the tranche B buyers 108b in proportion to the amount of CERs each buyer purchased in tranche B until the received CERs are depleted or until all tranche B CER obligations are fulfilled. The CER calculation and distribution module 214 can distribute the CERs by debiting and crediting the appropriate registry accounts 204, 206, as discussed previously. Thus, the tranche B buyers 108b only receive their full amount of CERs if the seller 106 accumulated sufficient CERs during the accumulation period to cover those obligations. The tranche B buyers 108b benefit from the seniority of tranche B over tranche C. Accordingly, CERs in tranche B may sell for a higher price than CERs in tranche C.

In step 535, the CER calculation and distribution module 214 determines whether any CERs remain to be distributed after meeting the tranche B obligations. For example, the CER calculation and distribution module 214 can make that determination if the accumulated CERs are greater than the CER obligations for tranches A and B. If not, then the method 350 branches to step 355 (FIG. 3), and the CER distribution is complete for the current accumulation period. If yes, then the method 350 branches to step 540.

In step 540, the CER calculation and distribution module 214 distributes remaining CERs to the tranche C buyer (or buyers 108a, 108b, 108c) until all tranche C CER obligations are met or until all of the CERs received during the accumulation period are distributed. Thus, the tranche C buyers 108c only receive their full amount of CERs if the seller 106 accumulated sufficient CERs during the accumulation period to cover those obligations. In step 545, if any CERs remain, the seller 106 will hold any remaining CERs in its CER registry account 204 until the next delivery date after the end of the next accumulation period. The method 350 then proceeds to step 355 (FIG. 3).

Referring back to steps 520, 530, and 540, if the payment collection from the buyers was deferred in step 430 (FIG. 4), the steps 520, 530, and 540 can include collecting payment from the buyers for the CERs being distributed to the buyers.

FIG. 6 is a block diagram depicting a system 600 for buying and selling certified emission reduction credits according to an alternative exemplary embodiment. The system 600 is similar to the system 100 with the additional features of novation deeds to transfer rights to future CERs to the seller and a custodian 602 to hold CERs in the event that CERs cannot be directly distributed to the seller 106. In this exemplary embodiment, either the transaction manager 110 or the custodian 602 will obtain initial rights to the CERs for the benefit of the seller 106, which rights are then transferred to the seller 106. This structure is beneficial when the agreement between the project developer 102 and the entity creating a specific one of the projects 104 designates either the custodian or the project developer 102 (and not the seller 106) as the entity that is to receive the CERs from the project. In an exemplary embodiment, the developer 102 can obtain rights to purchase the future CERs from the projects 104. Then, the project developer 102 can issue a novation deed to the project (or the entity responsible for the project), which can issue the novation deed to the seller 106. At this point, the seller 106 has all of the project developer's 102 rights to the future CERs, and the future CERs will be delivered directly to the seller 106 when available. In alternative embodiments, the holding company 107 or the custodian 602 can obtain the initial rights to the CERs in a similar arrangement to the project developer 102.

In certain countries such as China, CERs may only be delivered initially to an entity that is in China. In this case, the custodian 602 may be established in that country and can obtain rights to purchase the future CERs from the projects 104 in that country. Then, the custodian 602 can issue a novation deed to the seller 106. At this point, the seller 106 has all of the custodian's 602 rights to the future CERs, and the future CERs will be delivered directly from the custodian 602 to the seller 106 when received by the custodian 602. The custodian 602 holds a custody deed to hold the CERs until they can be properly transferred to the seller 106.

The present invention can be used with computer hardware and software that performs the methods and processing functions described above. As will be appreciated by those having ordinary skill in the art, the systems, methods, and procedures described herein can be embodied in a programmable computer, computer executable software, or digital circuitry. The software can be stored on computer readable media. For example, computer readable media can include a floppy disk, RAM, ROM, hard disk, removable media, flash memory, memory stick, optical media, magneto-optical media, CD-ROM, etc. configured to execute the methods and processing functions described herein. Digital circuitry can include integrated circuits, gate arrays, building block logic, field programmable gate arrays (FPGA), etc.

Although specific embodiments of the present invention have been described above in detail, the description is merely for purposes of illustration. It should be appreciated, therefore, that many aspects of the invention were described above by way of example only and are not intended as required or essential elements of the invention unless explicitly stated otherwise. Various modifications of, and equivalent steps corresponding to, the disclosed aspects of the exemplary embodiments, in addition to those described above, can be made by those skilled in the art without departing from the spirit and scope of the present invention defined in the following claims, the scope of which is to be accorded the broadest interpretation so as to encompass such modifications and equivalent structures.

What is claimed is:

1. A method for distributing units of carbon emission reduction (“CER”), comprising the steps of:
obtaining a right to purchase CERs that are expected to be generated in the future by at least one emission reduction project (“future CERs”);
establishing a plurality of tranches for delivery of future CERs to prospective buyers, the plurality of tranches each having different delivery obligations;
receiving bids from prospective buyers via an allocation module to purchase the future CERs in the tranches;
allocating via the allocation module the future CERs in the tranches among the prospective buyers based on the bids received in the receiving step; and
distributing via a distribution module CERs received from the at least one project (“received CERs”) to the prospective buyers based on the future CERs allocated in the allocating step and the different delivery obligations for the plurality of tranches,
wherein the allocation module and the distribution module are implemented in a computer system that comprises instructions stored in a machine-readable medium and a processor that executes the instructions.

2. The method of claim 1, wherein the different delivery obligations comprise different priorities of delivery.

3. The method of claim 1, wherein the distributing step comprises the steps of:
determining via the distribution module whether the received CERs are equal to or more than the future CERs allocated to the buyers for one of the tranches;
obtaining replacement CERs from an alternative source in response to determining that the received CERs are not equal to or more than the future CERs allocated to the buyers for the one of the tranches; and
distributing via the distribution module the received CERs and the replacement CERs to the buyers for the one of the tranches to meet CER obligations for the one of the tranches.

4. The method of claim 3, wherein, when the received CERs are not equal to or more than the future CERs allocated to the buyers for the one of the tranches, received CERs are not distributed to cover obligations for future CERs allocated to the buyers for another one of the tranches.

5. The method of claim 1, wherein the distributing step comprises the steps of:
debiting via the distribution module CERs from a registry account in which the received CERs are deposited; and
crediting via the distribution module CERs to a registry account for at least one of the buyers to which future CERs were allocated in the allocating step.

6. A method for buying and selling carbon credits, comprising the steps of:
contracting to purchase carbon credits that are expected to be generated in the future by a plurality of greenhouse gas emission reduction projects (“future carbon credits”);
establishing three tranches, A, B, and C, for selling the future carbon credits to prospective buyers, the three tranches each having different delivery obligations;
receiving bids from the prospective buyers via an allocation module to purchase the future carbon credits in the tranches A, B, and C;
allocating via the allocation module the future carbon credits in the tranches A, B, and C among the prospective buyers based on the bids received in the receiving step, thereby obligating future carbon credits to the buyers for the future carbon credits in tranches A, B, and C; and
distributing via a distribution module carbon credits actually received from the projects (“received carbon credits”) to the prospective buyers based on the future carbon credits allocated in the allocating step and the different delivery obligations for the three tranches,
wherein the allocation module and the distribution module are implemented in a computer system that comprises instructions stored in a machine-readable medium and a processor that executes the instructions.

7. The method of claim 6, wherein the different delivery obligations comprise different priorities of delivery.

8. The method of claim 6, wherein a cost per unit of carbon credit for carbon credits in tranche A is higher than a cost per unit of carbon credit for carbon credits in tranches B or C.

9. The method of claim 6, wherein the distributing step comprises the steps of:
debiting via the distribution module carbon credits from a registry account in which the received carbon credits are deposited; and
crediting via the distribution module carbon credits to a registry account for at least one of the buyers to which future carbon credits were allocated in the allocating step.

10. The method of claim 6, further comprising the step of obtaining a contingent call option to provide replacement carbon credits to cover obligations of future carbon credits for tranche A.

11. The method of claim 10, wherein the distributing step comprises the steps of:
determining via the distribution module whether the received carbon credits are equal to or more than the future carbon credits obligated to the buyers for tranche A;
obtaining the replacement carbon credits via the contingent call option in response to determining that the received carbon credits are not equal to or more than the future carbon credits allocated to the buyers for tranche A; and
distributing via the distribution module the received carbon credits and the replacement carbon credits to the buyers of future carbon credits in tranche A to meet the future carbon credit obligations for tranche A.

12. The method of claim 10, wherein, when the received carbon credits are not equal to or more than the future carbon credits allocated to the buyers for tranche A, received carbon credits are not distributed to cover obligations for future carbon credits allocated to the buyers for tranches B and C.

13. The method of claim 10, wherein, when the received carbon credits are more than the future carbon credits allocated to the buyers for tranche A, the distributing step comprises distributing via the distribution module the received carbon credits to buyers for tranche A to meet the future carbon credit obligations for tranche A and distributing any remaining received carbon credits to the buyers for tranches B and C.

14. The method of claim 13, wherein the distributing step further comprises the steps of:
determining via the distribution module whether the remaining received carbon credits are equal to or more than the future carbon credits obligated to the buyers for tranche B; and
distributing via the distribution module the remaining received carbon credits only to meet the future carbon credit obligations for tranche B in response to a determination that the remaining received carbon credits are not equal to or more than the future carbon credits obligated to the buyers for tranche B, and
wherein received carbon credits are not distributed to cover obligations for future carbon credits allocated to the buyers for tranche C in response to a determination that the remaining received carbon credits are not equal to or more than the future carbon credits obligated to the buyers for tranche B.

15. The method of claim 13, wherein the distributing step further comprises the steps of:
determining via the distribution module whether the remaining received carbon credits are equal to or more than the future carbon credits obligated to the buyers for tranche B;
distributing via the distribution module remaining received carbon credits to meet the future carbon credit obligations for tranche B in response to a determination that the remaining received carbon credits are more than the future carbon credits obligated to the buyers for tranche B; and
distributing via the distribution module any received carbon credits that still remain to the buyers for tranche C.

16. A computer program product having stored therein a set of instructions that when executed cause a computer to implement a process of distributing units of carbon emission reduction (“CER”), which comprises the steps of:
obtaining a right to purchase CERs that are expected to be generated in the future by at least one emission reduction project (“future CERs”);
establishing a plurality of tranches for delivery of future CERs to prospective buyers, the plurality of tranches each having different delivery obligations;
receiving bids from prospective buyers to purchase the future CERs in the tranches;
allocating the future CERs in the tranches among the prospective buyers based on the bids received in the receiving step; and
distributing CERs received from the at least one project (“received CERs”) to the prospective buyers based on the future CERs allocated in the allocating step and the different delivery obligations for the plurality of tranches.

17. A computer program product having stored therein a set of instructions that when executed cause a computer to implement a process of buying and selling carbon credits, which comprises the steps of:
contracting to purchase carbon credits that are expected to be generated in the future by a plurality of greenhouse gas emission reduction projects (“future carbon credits”);
establishing three tranches, A, B, and C, for selling the future carbon credits to prospective buyers, the three tranches each having different delivery obligations;
receiving bids from the prospective buyers to purchase the future carbon credits in the tranches A, B, and C;
allocating the future carbon credits in the tranches A, B, and C among the prospective buyers based on the bids received in the receiving step, thereby obligating future carbon credits to the buyers for the future carbon credits in tranches A, B, and C; and
distributing carbon credits actually received from the projects (“received carbon credits”) to the prospective buyers based on the future carbon credits allocated in the allocating step and the different delivery obligations for the three tranches.
